(19) United States
(12) Patent Application Publication
(10) Pub. No.: US 2023/0235857 A1
(43) Pub. Date: Jul. 27, 2023

(54) Dual-Purpose Cryogenic Liquid Tank System and Method

(71) Applicant: Chart Inc., Ball Ground, GA (US)

(72) Inventors: Jan Kubica, Liberec (CZ); Petr Zaruba, Decin (CZ)

(21) Appl. No.: 18/158,168

(22) Filed: Jan. 23, 2023

Related U.S. Application Data
(60) Provisional application No. 63/303,295, filed on Jan. 26, 2022.

(51) Int. Cl. F17C 13/00

(52) U.S. Cl. CPC F17C 13/001; F17C 2223/0161; F17C 2201/0109; F17C 2203/0391; F17C 2221/014; F17C 2227/0353; F17C 2203/012

(57) ABSTRACT

A tank system and method for storing cryogenic liquids includes a support cooling channel to reduce heat leak into the vessel of a fuel tank. The fuel tank may store either liquid natural gas or liquid hydrogen or another cryogenic liquid. A cooling fluid is transferred from a second vessel into the support cooling channel of the fuel tank.

### CLAIM OF PRIORITY

This application claims the benefit of U.S. Provisional Application No. 63/303,295, filed Jan. 26, 2022, the contents of which are hereby incorporated by reference.

### FIELD OF THE DISCLOSURE

The present disclosure relates generally to cryogenic liquid storage tanks and, more particularly, to a cryogenic liquid tank system and method that alternatively stores two different types of cryogenic liquids having different thermodynamic properties.

### BACKGROUND

Liquified natural gas (LNG) is commonly used as a fuel for powering ships. With the goal of lowering emissions from the maritime industry, potential alternative fuels have been identified. One such alternative fuel is liquified hydrogen (LH₂).

Marine industry regulations specify very strict requirements for fuel tank structural integrity and durability. Furthermore, marine fuel tanks must be capable of holding evaporated fuel without venting for a specified time period (typically 15 or 21 days) in the event that the ship cannot consume fuel for an extended period of time. Heat leakage from the ambient environment into the liquid fuel within the tank therefore must be managed.

Because LNG is the predominant fuel used in the marine industry, most currently used fuel tanks are built in a configuration to accommodate the properties of LNG. As LH₂ becomes more commonly used as a fuel source, many such storage tanks will become unusable because of the thermodynamic differences between LNG and LH₂. For instance, LNG is warmer, heavier, and more capable of heat absorption, whereas LH₂ is colder, lighter, and less capable of heat absorption.

Because of the weight of LNG, current LNG storage tanks require substantial supports for supporting the inner vessel containing the LNG within the insulating outer jacket. The substantial supports may conduct a large amount of heat into the liquid of the inner vessel. As a result, if LH₂ is stored in such a tank, the heat leak from the supports may cause a substantial amount of evaporation of LH₂, considerably reducing the tank holding time.

Therefore, there is a need for a dual-purpose tank capable of storing fuels or other cryogenic liquids having different thermodynamic properties.

### SUMMARY OF THE DISCLOSURE

There are several aspects of the present subject matter which may be embodied separately or together in the methods, devices and systems described and claimed below. These aspects may be employed alone or in combination with other aspects of the subject matter described herein, and the description of these aspects together is not intended to preclude the use of these aspects separately or the claiming of such aspects separately or in different combinations as set forth in the claims appended hereto.

In one aspect, a tank system for storing a cryogenic liquid includes a first tank having a first vessel configured to store the cryogenic liquid, a first outer jacket surrounding the first vessel and a support securing the first vessel within the first outer jacket and spacing the outer jacket from the first vessel. A support cooling channel contacts the support. A second vessel stores and supplies a cooling fluid to the support cooling channel.

In another aspect, a method of storing a cryogenic liquid includes the steps of storing a cryogenic liquid in a first vessel of a first tank, where the first tank also has a first outer jacket and a support securing the first vessel within the first outer jacket and spacing the outer jacket from the first vessel and cooling the support with a cooling fluid.

### BRIEF DESCRIPTION OF THE DRAWINGS

FIG. 1 is a schematic illustrating a first embodiment of the dual-purpose tank system of the disclosure.

FIG. 2 is a schematic illustrating a second embodiment of the dual-purpose tank system of the disclosure.

FIG. 3 is a schematic illustrating a third embodiment of the dual-purpose tank system of the disclosure.

### DETAILED DESCRIPTION OF EMBODIMENTS

A more detailed description of the system and method in accordance with the present disclosure is set forth below. It should be understood that the description below of specific systems and methods is intended to be exemplary, and not exhaustive of all possible variations or applications. Thus, the scope of the disclosure is not intended to be limiting and should be understood to encompass variations or embodiments that would occur to persons of ordinary skill.

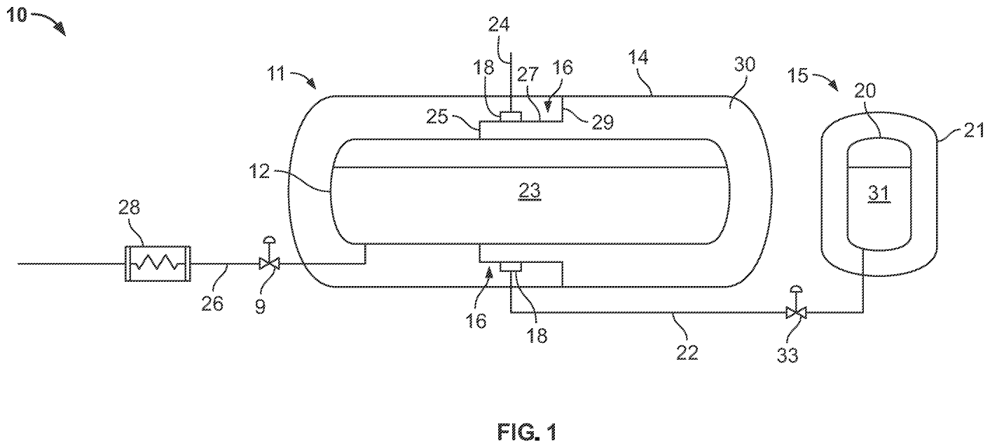

FIG. 1 shows a schematic illustration of a dual-purpose tank system, indicated in general at 10. Dual-purpose tank system 10 includes a first tank, indicated in general at 11, having a first inner vessel 12 and a first outer jacket 14. The system also includes a second tank, indicated in general at 15, having a second inner vessel 20 and a second outer jacket 21.

The first tank 11 stores a fuel 23 within the inner vessel 12. The fuel may be either liquified natural gas (LNG) or liquid hydrogen (LH₂). Other fuels or cryogenic liquids known in the art may be used without departing from the scope of the disclosure. The first inner vessel 12 is in fluid communication with a fuel line 26 and a fuel evaporator 28. Fuel 23 is withdrawn from tank 11 via use line 26, under the control of valve 9, and is vaporized via fuel evaporator 28 for consumption.

The first vessel 12 has a support system, including one or more supports, indicated in general at 16, which spaces the outer jacket 14 from the first vessel 12. In one embodiment, the support 16 may surround or partially surround the first vessel 12 in a continuous fashion. In another embodiment, the supports 16 may intermittently extend radially from the first vessel 12 to the outer jacket 14, such as at the top, bottom and sides. In either case, the support(s) 16 may have a tiered shape, as illustrated in FIG. 1, including a first radially-extending portion 25 extending from the first vessel 12, a joining portion 27 parallel to the length of the first vessel 12 and extending perpendicular from the first vertical portion, and a second radially-extending portion 29 running parallel to the first vertical portion and extending perpendicular from the joining portion to the outer jacket 14. Such an arrangement provides a longer heat transfer pathway between the inner vessel 12 and the outer jacket 14 of the first tank for the support(s) 16. The support(s) 16 may be made of, for example, but not limited to, steel, or any other material known in the art for such applications, without departing from the scope of the disclosure.

The space between the first vessel 12 and the first outer jacket 14 created by the support(s) 16 may be filled with an insulation material 30. Insulation material 30 is used to prevent ambient heat from the environment outside the dual-purpose tank 10 from leaking into the first vessel 12. Such heat leak may cause the fuel inside the first vessel 12 to evaporate before use. In one embodiment, the insulation material 30 is vacuum insulation material. In another embodiment, the insulation material 30 is multi-layer insulation (MLI). Other insulation material 30 known in the art may be used without departing from the scope of the disclosure.

To further reduce heat leak into the first vessel 12 along the support(s) 16, each support is provided with a support cooling channel 18. While the presented embodiments are described below in terms of a single support having a single channel, it is to be understood that alternative embodiments may include multiple supports with each having one or more support cooling channels. In addition, while the cooling channel is illustrated as having a rectangular cross sectional profile, the channel may feature an alternative profile. The support cooling channel 18 is used to cool the support 16 when LH₂ is stored in the first inner vessel 12 to prevent heat leak into the first vessel 12 and to prevent evaporation of the fuel 23. The support cooling channel 18 may also be used to cool the support 16 to reduce heat leak when LNG is stored within the first inner vessel 12.

The support cooling channel 18 is located on and in contact with the support 16 between the first inner vessel 12 and the first outer jacket 14. The support cooling channel 18 is preferably positioned on the support 16 midway between the first inner vessel 12 and the first outer jacket 14. In the embodiment where the support 12 surrounds or nearly surrounds the inner vessel 12, the support cooling channel 18 is also concentrically disposed or arcuately disposed about the first vessel 12.

Support cooling channel 18 is in fluid communication with a cooling line 22. Cooling line 22 is also in fluid communication with the second inner vessel 20 of second tank 15. The second vessel 20 stores a cooling fluid 31. Cooling fluid from the second vessel 20 travels through the cooling line 22, such as by gravity, and into the support cooling channel 18 as controlled by valve 33. In alternative embodiments, the cooling fluid 31 may be pumped to support cooling channel 18.

Due to the cooling of the support 16 by the cooling fluid withing cooling channel 18, heat leak along the support 16 from the outer jacket 14 to the first vessel 12 is reduced. Evaporated cooling fluid exits the cooling channel 18 via a vent 24. In one embodiment, the cooling fluid 31 is liquid nitrogen (LIN). Other cooling fluids known in the art may be used without departing from the scope of the disclosure.

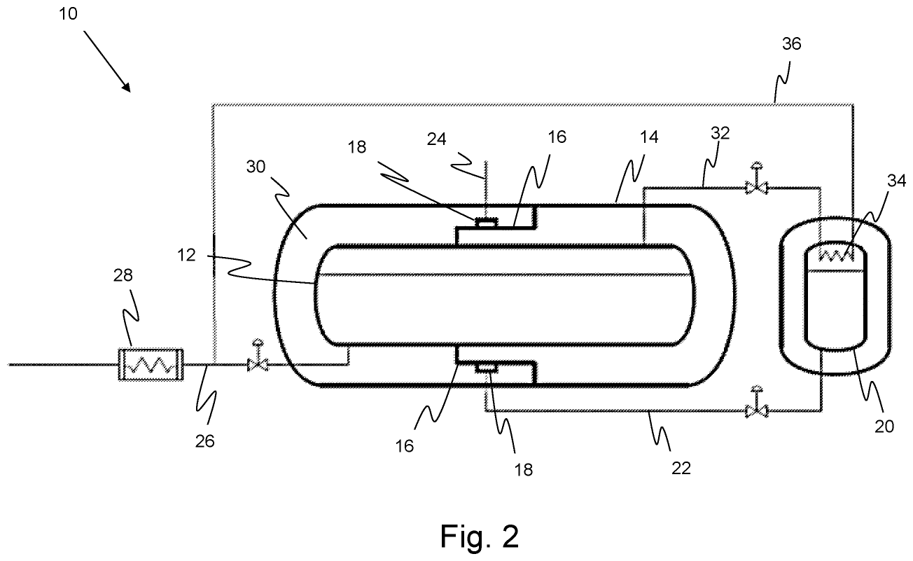

In some applications, the cooling fluid 31 may evaporate while it is stored in the second vessel 20. In a second embodiment of the disclosure, shown in FIG. 2, evaporation of the cooling fluid may be reduced or even eliminated using a condensation loop. More specifically, as illustrated in FIG. 2, the first vessel 12 may be in fluid communication with a recondensation line 32. Recondensing fluid may travel through the recondensation line 32 into a recondenser 34, which may be, as an example only, a cooling coil. The recondenser 34 is located in the headspace of the second inner vessel 20. The recondensing fluid is warmed in the recondenser 34, condensing evaporated cooling fluid in the second vessel 20. After traveling through the recondenser 34, the recondensing fluid exits through the exit line 36 which is in fluid communication with the fuel line 26. The recondensing fluid may then be used as fuel.

In the embodiment illustrated in FIG. 2, the recondensing fluid may be hydrogen vapor found in the headspace of the first vessel 12. In another embodiment, the recondensing fluid may be liquified hydrogen found in the bottom of the first vessel 12.

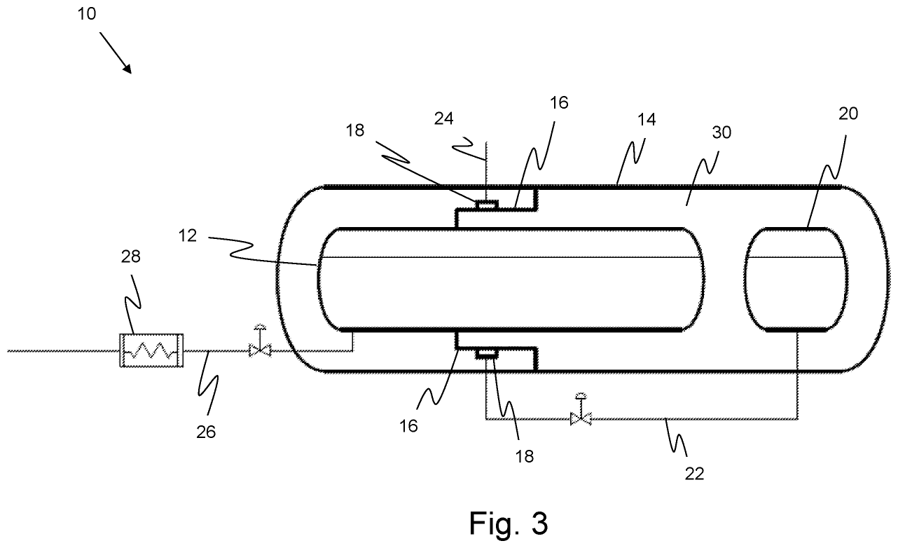

In a third embodiment of the disclosure, illustrated in FIG. 3, the second vessel 20 is located within the first outer jacket 14. Second vessel 20 may be surrounded by the same insulation that surrounds the first vessel 12. In one embodiment this may be vacuum insulation. In another embodiment this may be MLI. Other insulation material known in the art may be used without departing from the scope of the disclosure.

### Example

In an example, the properties of a vacuum-insulated tank without a support cooling channel was filled with LNG and compared to the same tank filled with LH₂. Table 1 below shows the values measured.

TABLE 1
Tank without a support cooling channel

| | LNG | LH₂ |
|---|---|---|
| Ambient Temperature | +45° C. | +45° C. |
| Fluid Temperature | −165° C. | −253° C. |
| Temperature Difference | 210 K | 298 K |
| Insulation Heat Leak | 164 W | 210 W |
| Support Heat Leak | 746 W | 1058 W |
| Total Heat Leak | 910 W | 1268 W |
| Specific Heat Leak | 2.8 W/m³ | 3.9 W/m³ |
| Holding Time Between 5 | 68 days | 10 days |
| barg and 10 barg | | |

Heat leakage data was collected from a fuel tank filled with LH₂ as fuel 23 with LIN used as the cooling fluid 31 in the embodiment illustrated in FIG. 1 under conditions of Table 1. Table 2 below shows the values measured.

TABLE 2
Tank with a support cooling channel

| | LH₂ |
|---|---|
| Support Heat Leak | 177 W |
| Total Heat Leak | 387 W |
| Specific Heat Leak | 1.2 W/m³ |
| Holding Time Between 5 | 31 days |
| barg and 10 barg | |

As seen in Table 2, LIN running through the support cooling channel reduces the amount of heat leak from the support to 177 W, resulting in an increased holding time of 31 days. In such an example, about 1 m³/day of LIN is consumed.

While the preferred embodiments of the disclosure have been shown and described, it will be apparent to those skilled in the art that changes and modifications may be made therein without departing from the spirit of the disclosure, the scope of which is defined by the following claims.

What is claimed is:

1. A tank system for storing a cryogenic liquid comprising:
a first tank including:
a first vessel configured to store the cryogenic liquid;
a first outer jacket surrounding the first vessel;
a support securing the first vessel within the first outer jacket and spacing the outer jacket from the first vessel;
a support cooling channel contacting the support; and
a second vessel configured to store and supply a cooling fluid to the support cooling channel.

2. The tank system of claim 1, wherein the support at least partially surrounds the first vessel.

3. The tank system of claim 2, wherein the support extends radially from the first vessel towards the outer jacket.

4. The tank system of claim 1, further comprising a second outer jacket surrounding the second vessel.

5. The tank system of claim 1, wherein the outer jacket surrounds the first vessel and the second vessel.

6. The tank system of claim 1, wherein the support cooling channel is located midway between the first vessel and the outer jacket.

7. The tank system of claim 1 further comprising a recondenser positioned within a headspace of the second vessel, said recondenser configured to receive fluid from the first vessel so that evaporated cooling fluid is condensed and a pressure within the second vessel is reduced.

8. The tank of claim 1, further comprising a cooling line in fluid communication with the second vessel and wherein the support cooling channel is in fluid communication with the cooling line.

9. The tank system of claim 8, wherein the cooling line includes a cooling line valve.

10. The tank system of claim 1, wherein the support cooling channel includes a vent.

11. The tank system of claim 1, further comprising vacuum insulation in between the first vessel and the first outer jacket.

12. The tank system of claim 1, wherein the first vessel is configured to store a cryogenic liquid fuel.

13. The tank system of claim 12, wherein the cryogenic liquid fuel is liquid natural gas or liquid hydrogen.

14. The tank system of claim 1, wherein the support includes a first radially-extending portion connected to the first vessel, a second radially-extending portion connected to the first outer jacket and a joining portion extending perpendicular between and connected to the first and second radially-extending portion.

15. The tank system of claim 1, wherein the cooling fluid is liquid nitrogen.

16. A method of storing a cryogenic liquid comprising the steps of:
storing a cryogenic liquid in a first vessel of a first tank, said first tank also including a first outer jacket and a support securing the first vessel within the first outer jacket and spacing the outer jacket from the first vessel, and
cooling the support with a cooling fluid.

17. The method of claim 16, wherein the cryogenic liquid is a fuel including liquid natural gas or liquid hydrogen.

18. The method of claim 16, wherein the cooling fluid is liquid nitrogen.

19. The method of claim 16, further comprising the step of storing the cooling fluid.

20. The method of claim 16 further comprising the step of venting evaporated cooling fluid during cooling of the support.
